(19) United States
(12) Patent Application Publication
(10) Pub. No.: US 2017/0116589 A1
(43) Pub. Date: Apr. 27, 2017

(54) PORTABLE POINT-OF-SALE DEVICES

(71) Applicant: PAYPAL, INC., San Jose, CA (US)

(72) Inventor: Akshay Sanjeevaiah Krishnaiah, San Jose, CA (US)

(21) Appl. No.: 14/984,055

(22) Filed: Dec. 30, 2015

Related U.S. Application Data
(60) Provisional application No. 62/245,923, filed on Oct. 23, 2015.

(51) Int. Cl. G06Q 20/20; G06Q 30/06

(52) U.S. Cl. CPC G06Q 20/202; G06Q 30/0633

(57) ABSTRACT

A portable point-of-sale device/system is provided that facilitate the checkout process for consumers shopping in retail stores. In particular, the portable point-of-sale device may allow a consumer to checkout and pay for a purchase at any location in the store, without the need to wait in line at the checkout counter. When a shopper is ready to checkout and pay for a purchase, the system/device may locate and notify an available store associate located nearest to the shopper. The profile of the shopper, the location of the shopper in the store, and the list of products to be purchased by the shopper may be communicated to the merchant device carried by the store associate. The store associate may meet the shopper at the shopper's location, verify the products to be purchased, and process payment for the purchase in a checkout process.

### CROSS REFERENCE TO RELATED APPLICATION

Pursuant to 35 U.S.C. §119(e), this application claims priority to the filing date of U.S. Provisional Patent Application Ser. No. 62/245,923, filed Oct. 23, 2015, which is incorporated by reference in its entirety.

### BACKGROUND

Field of the Invention

The present invention generally relates to portable point-of-sale devices, and more particularly to devices that process location and other data for in-store navigation and service.

Related Art

Consumers shopping at retail stores typically walk around the store to browse and pick up products, and thereafter pay for the picked up products at a checkout counter. During peak hours, the consumer traffic in a retail store may become very busy and the store may become very crowded. As such, the check-out counter can become a traffic bottleneck with long lines of consumers waiting to check out and pay for their purchases. This may cause inconvenience for the consumers, especially for consumers with special needs, such as consumers with little children, who may not be willing to wait in long lines at retail stores. Thus, there is a need for a solution to reduce the traffic bottleneck at the checkout counter.

### BRIEF DESCRIPTION OF THE FIGURES

FIG. 1 is a block diagram of a networked system suitable for implementing mobile point-of-sale devices according to an embodiment.

FIG. 2 is a flowchart showing a process for facilitating shopping activities for shoppers according to an embodiment.

FIG. 3 is a flowchart showing a process for implementing mobile point-of-sale devices in a retail store according to one embodiment.

FIG. 4 is a block diagram of a computer system suitable for implementing one or more components in FIG. 1 according to one embodiment.

FIG. 5 is a diagram depicting a floor layout of a merchant store according to one embodiment.

FIG. 6 is a diagram depicting a network of beacons according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, portable point-of-sale device/system is provided that facilitates the checkout process for consumers shopping in retail stores. In particular, the portable point-of-sale device may allow a consumer to checkout and pay for a purchase at any location in the store, without the need to wait in line at the checkout counter. When a shopper is ready to checkout and pay for a purchase, the system/device may locate and notify an available store associate located nearest to or able to respond quickest to the shopper. The profile of the shopper, the location of the shopper in the store, and the list of products to be purchased by the shopper may be communicated to the merchant device carried by the store associate. The store associate may meet the shopper at the shopper's location, verify the products to be purchased, and process payment for the purchase in a checkout process. Thus, the shopper may pay and checkout at any location in the store, without having to wait in line at the checkout counter.

In an embodiment, a shopper may download a shopping app onto the shopper's mobile device. The shopping app may be configured to be used at participating retail stores. The shopping app may provide various functions that facilitate shopping at the participating retail stores, such as providing directions, store information, coupons, promotions, and the like.

When a shopper arrives at a retail store, the mobile device of the shopper may detect that the shopper is visiting a particular retail store. The shopping app of the mobile device may retrieve information related to the store and may welcome the shopper with a message from the retail merchant which may include promotions, specials, and/or coupons or other incentives that may be used by the shopper. The location and movement of the shopper may be detected and monitored by shopper positioning devices (such as through a grid of wireless beacons) installed in the retail store.

Store associates at the retail store may each carry a merchant device that may provide shopper information to the store associates and may notify store associates if certain shoppers require shopping assistance. In an embodiment, the merchant device may provide an interface that allows the store associate to visualize (via animation) shoppers' location and movement in the store.

During the shopping process, the shopper may use the shopping app on the shopper's mobile device to scan the barcodes or QR codes provided on the products or near the product sections when the shopper adds the products into the shopping cart. The shopper's shopping activities, such as adding products into shopping cart, also may be monitored and presented to the merchant. For example, the merchant device may provide an interface that allows the store associate to visualize shoppers' shopping activities. The interface may have animations representing the shopper that glow as soon as the shopper starts scanning a product indicating that the shopper is adding a product to his/her purchase.

When the shopper finishes shopping and is ready to checkout and pay, the shopper may click on an “omnipresent done” button provided in the shopping app to finish adding products to cart and process payment on the mobile device using the shopping app. The shopper may choose from various payment methods (PayPal/apple pay etc.). The system may then determine, queue up, and notify store associates who are available and located near the shopper in the store. The nearby store associates may be notified that the shopper is ready to checkout. In an embodiment, a specific store associate may be assigned to help the shopper, based on information enabling the system to determine that the specific store associate can respond quickest to the shopper, and the system may communicate the shopper's information to the merchant device carried by the assigned store associate, including the shopper's name, picture, location, and the like.

The shopper may be notified that the payment is processed and that a nearby store associate is on his/her way to help the shopper finish the checkout process. In particular, the system may provide the shopper with the name and/or picture of the store associate who is coming to help the shopper, the location and/or distance of the store associate, and the estimated time of arrival of the store associate.

When the store associate arrives and meets the shopper, the store associate may verify the payment and products purchased in the shopping cart and may complete the checkout process for the shopper. For example, a list of products purchased and paid for by the shopper may be communicated to the merchant device carried by the store associate. The store merchant may verify the list of products paid for by the shopper with the products added in the shopper's shopper cart. After the store associate verifies the purchase and store associate may confirm on store associate's merchant device and the system may complete the checkout process. The shopper may be notified on the shopping app of the shopper's mobile device that the checkout process is completed.

The portable point-of-sale devices and related systems may be utilized in various retail settings, such as grocery stores, retail stores, holiday shopping, drive-through, fast food restaurants, and the like.

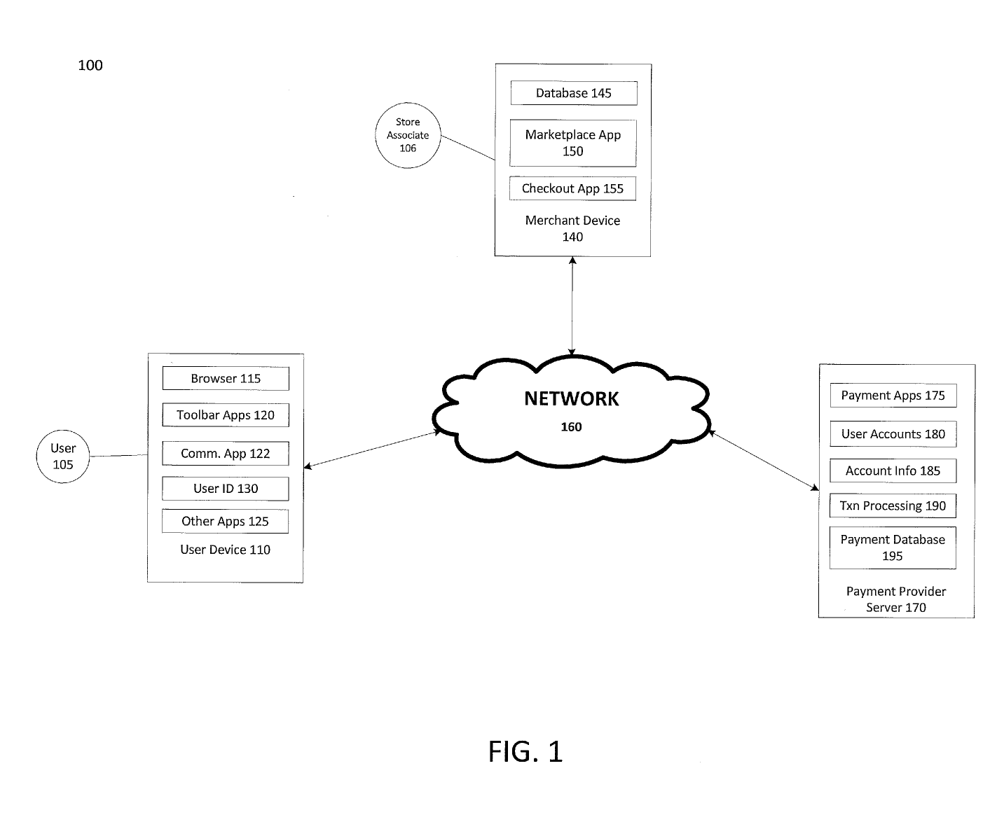

FIG. 1 is a block diagram of a networked system 100 suitable for implementing portable point-of-sale devices/systems according to an embodiment. Networked system 100 may comprise or implement a plurality of servers and/or software components that operate to perform various shopping applications, payment transactions, or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, one or more merchant devices 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to shop, initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account.

In some embodiments, user device 110 may download a shopping application from payment provider server 170 or from merchant device 140. The shopping application may allow user 105 to facilitate shopping activities at a participating retail store. User device 110 may include a Bluetooth device configured to implement low energy Bluetooth communication. A network of low energy Bluetooth beacons may be installed at various locations inside the merchant's store. Thus, the location and movements of user device 110 in the merchant's store may be determined by detecting the various Bluetooth beacons installed in the merchant's store. When user 105 utilizes the shopping application on user device 110 to scan and purchase products in a retail store, the locations and movements of user 105 in the merchant's store may be monitored.

User device 110, merchant devices 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for facilitating shopping at retail stores. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include a Bluetooth device configured to implement low energy Bluetooth (BLE) communication. For example, user device 110 may include a location detection device including the Bluetooth device that detects various low energy Bluetooth signals from Bluetooth beacons installed in a merchant's store. Thus, locations and movements of user device 110 may be determined by positioning techniques, such as triangulation or location fingerprinting.

Merchant devices 140 may be maintained, for example, by a merchant or a seller offering various products and/or services. The merchant may have a physical point-of-sale (POS) store front. The merchant may be a participating merchant who has a merchant account with the payment service provider. Merchant devices 140 may be portable POS devices carried by store associates. Merchant devices 140 may include similar components as those in the user device 110 and may include an application configured to allow store associates to view shopping activities of shoppers in the retail store, receiving requests from shoppers for shopping assistance, implement checkout process, and the like.

The merchant device 140 may further include a database 145 identifying available products (including digital goods) and/or services (e.g., collectively referred to as items). Merchant device 140 may include a checkout application 155 which may be configured to facilitate the purchase made by user 105 of goods or services at a store. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant device 140 may be configured to detect and/or interact with a network of Bluetooth beacons installed in the merchant's brick-and-mortar store. The network of Bluetooth beacons may be installed at respective locations throughout the merchant's store to form a grid. Each Bluetooth beacon may emit a low energy Bluetooth signal in specific frequency spectrum periodically. Thus, the network of Bluetooth may allow detection of locations and movements of shoppers and store associates in the merchant's store.

Payment provider server 170 may be maintained, for example, by an online payment service provider which may provide payment between user 105 and the operator of merchant device 140. In this regard, payment provider server 170 includes one or more payment applications 175 which may be configured to interact with user device 110 and/or merchant device 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

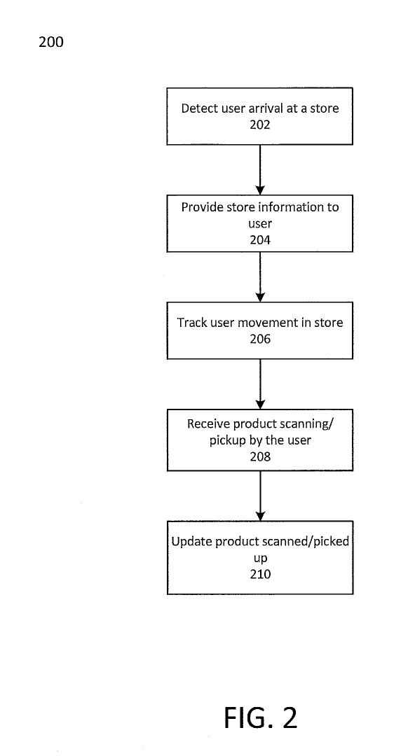

FIG. 2 is a flowchart showing a process 200 for facilitating shopping activities for shoppers in a store according to one embodiment. At step 202, user device 110 or merchant device 140 may detect that the user 105 (shopper) is approaching or arriving a retail store. This may be done by GPS or by detection of a wireless beacon (BLE beacon) installed at the retail store, or by the user checking-in at the retail store on the social network, or the like.

At step 204, the system may provide store information to the user 105 at the user device 110. The store information may include the name of the store, the type of products/services offered, store layout, the user's purchase history at the store, type of payments accepted, store hours, coupons, discounts, specials, or other incentives that may be used by the user, and other store information. The system also may allow the user 105 to perform a search for products or services offered at the retail store using the user device 110.

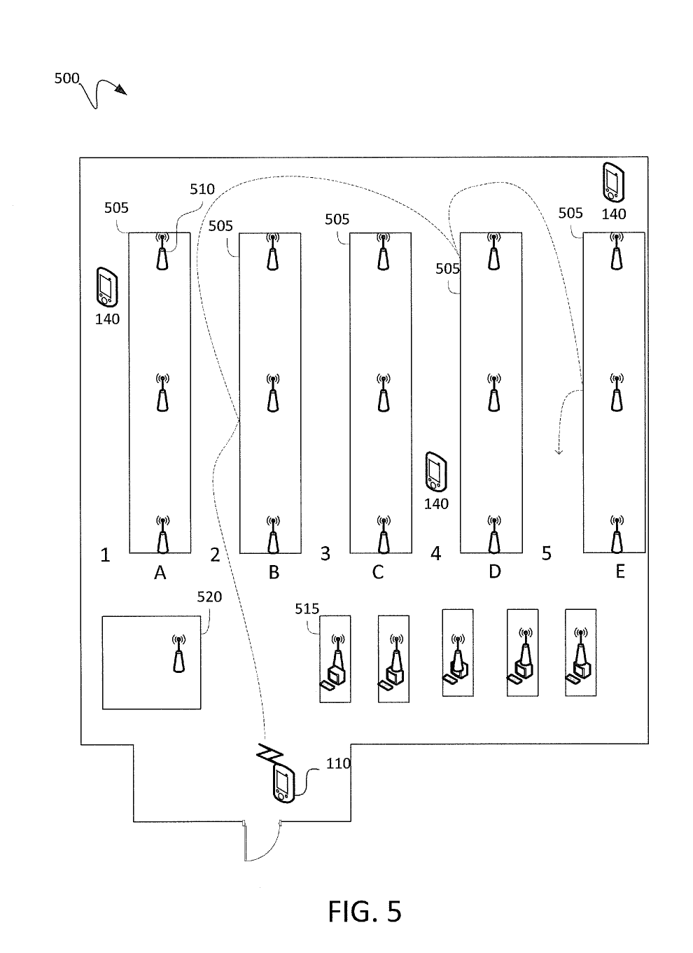

At step 206, the system may track the user 105's location and movement in the store. The location and movement of the user device 110 (and thus the user 105) may be detected and tracked by wireless beacon devices installed throughout the retail store. The location and movement of store associates also may be detected and tracked similarly by tracking the merchant devices 140 carried by the store associates. As shown in FIG. 5, as an example, a grocery merchant may include selves 505. Each shelf 505 in the store may have three Bluetooth beacons 510: one at the front section, one at the middle section, and one at the rear section. Each checkout counter 515 also may have a Bluetooth beacon 510. Further, one Bluetooth beacon 510 may be installed at a customer service counter 520 near the entrance of the store. The network of Bluetooth beacons 510 may be connected to merchant device 140. Each Bluetooth beacon 510 may emit a low energy Bluetooth signal with specific frequency spectrum User 105 may carry a user device 110 including a Bluetooth device configured to communicate via low energy Bluetooth communication. When user 105 enters the merchant's store, user device 110 may detect Bluetooth beacons 510 installed near the store's entrance, such as the Bluetooth beacon 510 at customer service counter 520 and the Bluetooth beacon 510 at a checkout counter 515. Thus, the position of user device 110 (and merchant device 140) may be determined based on which Bluetooth signals are received and the respective signal strength of the signals.

For example, user device 110 may receive Bluetooth signals from one or more of the beacons from the network of beacons installed at the merchant's store. Each Bluetooth beacon installed at the merchant's store may emit a unique signal. A Bluetooth beacon database may be used to store profiles for each Bluetooth beacon. For example, each Bluetooth beacon may have a profile containing the Bluetooth beacon's location in the store, the unique signal signature of the beacon, the signal strength of the beacon, and the like. When user device 110 is at a certain location in the merchant's store, user device 110 may receive one or more Bluetooth signals emitted from Bluetooth beacons located near user device 110.

The position of user device 110 may be determined based on the Bluetooth signals received at user device 110 using techniques, such as triangulation or location fingerprinting. In the triangulation technique, the location of user device 110 may be determined based on the locations of three Bluetooth beacons 510 and the distance of user device 110 from the two or more Bluetooth beacons 510. The locations of the Bluetooth beacons 510 may be predetermined when the Bluetooth beacons 510 are installed on the shopping floor of the store. The distance between the Bluetooth beacons 510 and user device 110 may be determined based on the signal strength received between the Bluetooth beacons 510 and user device 110. A stronger signal may indicate a shorter distance while a weaker signal may indicate a longer distance. Thus, based on the Bluetooth signals between the Bluetooth beacons 510 and user device 110, the location of user device 110 may be determined using the triangulation technique.

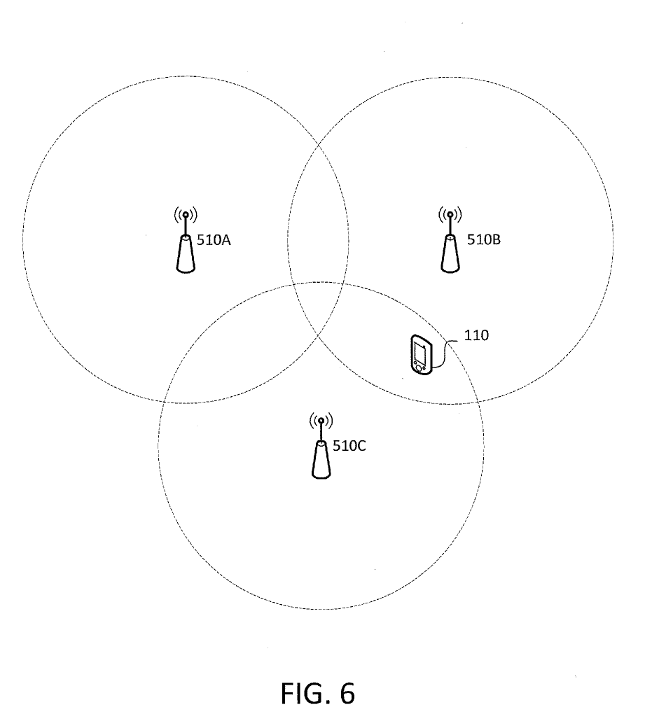

For example, as shown in FIG. 6, three Bluetooth beacons 510A, 510B, and 510C may each emit a unique Bluetooth signal. The signal range of each beacon may be illustrated as a circle of dashed line surrounding each beacon. As shown in FIG. 6, user device 110 may be located at a position at which user device 110 receives signals from beacon 510B and beacon 510C, but not beacon 510A. In particular, user device 110 receives signals with about the same signal strength from both beacons 510B and 510C. Thus, user device 110 is located between an area between beacons 510B and 510C, but away from 510A. Further, based on the signal strengths of the signals, the distance between user device 110 and beacons 510B and 510C may be determined. User device 110 or payment provider server 170 may analyze the signals and their signal strengths received at user device 110 and reference the locations of the beacons that emit these signals to determine the location of user device 110 by triangulation techniques.

In the location fingerprint technique, a database of signal fingerprints at various locations on the shopping floor may be predetermined. For example, a signal profile may be predetermined for each location. The signal profile may include Bluetooth signals that are detected at that location and the strength of each of those detected Bluetooth signals. For example, as shown in FIG. 6, when user device 110 is positioned at a certain position between beacons 510B and 510C, a signal profile may be predetermined to indicate medium signals from beacons 510B and 510C and low or no signal from beacon 510A. A database of signal profiles associated with a plurality of respective locations on the shopping floor may be predetermined and stored. Thus, based on a signal profile detected by user device 110, a location of user device 110 may be determined by referencing the database of signal profiles.

In some embodiments, the signal profile may be the Bluetooth signal of user device 110 received by respective Bluetooth beacons. For example, as shown in FIG. 6, when user device 110 is positioned between beacons 510B and 510C, a signal profile may be predetermined to indicate medium signals received by beacons 510B and 510C, and weak or no signal received at beacon 510A. Thus, the signal fingerprints may be signals received by user device 110 or signals received by the respective Bluetooth beacons 510.

The location of user device 110 may be determined by user device 110. For example, user device 110 may download a layout map of the merchant and may determine user device 110's position based on the Bluetooth signals detected and the floor layout of the Bluetooth beacons 510. In some embodiments, merchant device 140 may determine the location of user device 110 based on which Bluetooth beacons 510 detect user device 110 and the strength of the signal detected at the Bluetooth beacons 510. In some embodiments, the detected signals and signal strengths may be forwarded to payment provider server 170 (or merchant device 140) and payment provider server 170 (or merchant device 140) may determine the location of user device.

At step 208, the system may receive product scanning from the user device 110. The user 105 may browse and pick up products for purchase. When the user 105 picks up a product, the user 105 may use the shopping app on the user device 110 to scan a bar code or QR code of the product as provided on the product or at the product section. The system or the user device 110 thus may record, maintain, and update a list of products that are picked up and placed in the user 105's shopping cart. The shopping app also may allow the user 105 to modify the list of products, such as deleting, change the number of items or the like. For example, when the user 105 decides to put a product back on a shelf, the user 105 may delete the product from the list of products to be purchased, or the product may be automatically deleted based on a detection that the product has been removed from the cart, such as through an RFID scanner in the cart and an RFID tag on the product. In an embodiment, the shopping app may identify a product by an image of the product taken using a camera of the user device 110, instead of scanning the bar/QR code. For example, the user 105 may capture an image of the product and the shopping app may identify the product based on the captured image.

At step 210, the system may continue to update the list of products to be purchased as the user 105 (shopper) continues to add products into the shopping cart during the shopping process. In some embodiments, location-based advertisements, coupons, incentives, and the like may be offered and/or displayed to the user 105 at the user device 110 as the user browses and shops in the retail store. The user 105 also may use the shopping app to ask questions and/or summon help from the store associates 106. For example, the user 105 may summon help of nearby store associates 133. When the user 105 summons help, the shopping app may cause the user device 110 to send a help request to the system. The system may locate the nearby store associates 106 by detecting and/or tracking the merchant devices 140 that the store associates 106 carry with them. If only one store associate is available, that store associate is notified to respond to the user. If more than one store associate is available, the system determines the store associate “best” suited for responding to the user. This can include the store associate who responds quickest to the user (even if farther away from the user than other store associates) or can better handle the user and/or purchases, as detailed below.

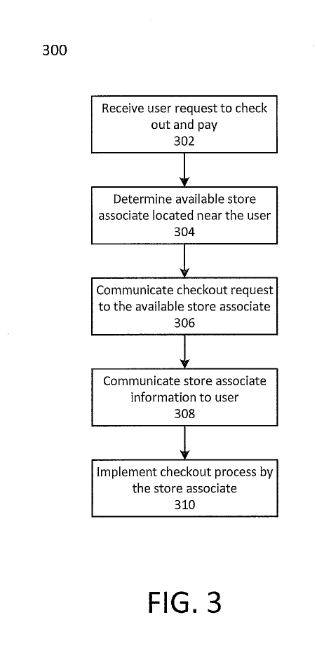

FIG. 3 is a flowchart showing a process 300 for implementing portable point-of-sale devices at a retail store according to one embodiment. At step 302, the system may receive the user 105's request to checkout and pay. The user 105 may click on a button on the shopping app at the user device 110 to indicate to the system that the user 105 is ready to checkout and pay for the products placed in the shopping cart. The user 105 may checkout and pay for the purchase anywhere in the store. For example, as show in FIG. 5, the shopper may finish picking up products in aisle 5. Thus, the shopper may request for checkout in aisle 5, without having to go to a checkout counter. The shopping app may display a summary of the products placed in the cart, respective prices, discounts applied, total purchase price, incentives for further discount, available payment methods, and the like. The shopping app may allow the user 105 the option of paying for the purchase now or wait for a store associate before making payments.

At step 304, the system may determine available store associates who are located near the user 105 in the store. The system may determine which store associates are not currently busy or helping other shoppers or store associates assigned with the least number of shoppers in queue. As noted above, the store associates' locations and movements may be detected and tracked by the merchant devices 140 they carry with them. As shown in FIG. 5, a merchant device 140 in the back of aisle one, another merchant device 140 is in the front of aisle 4, and still another merchant device 140 is at the far right back of the store. The locations of the respective merchant devices 140 may indicate the location of the store associates. The system may determine from the nearby store associates which is the closest and available store associate in view of the location of the user 110. A store associate may be select to help the user 110 with the checkout process.

Each store associate may have a queue of shoppers that the store associate is assigned to help. Shoppers may be prioritized based on their needs, their status/value, and the like. For example, a frequent shopper may be a VIP who moves to the front of the queue and is helped first by the store associate. In another example, a shopper with special needs (handicapped or with small children) may be moved up the queue to receive help first. Shoppers with less items in their shopping cart may be helped first (express lane).

Store associates may be assigned and matched to shoppers based on their personality and/or capability. Store associates with particular knowledge may be matched to shoppers buying products related to that particular knowledge. For example, a shopper may have buckets of paint and brush in the shopping cart. The system may assign a store associate who is specialized in paint jobs to the shopper, in the event that the shopper has questions about the purchase or the store associate may offer or suggest additional products or services related to paint job to the shopper. In an embodiment, shoppers may pay a fee to obtain immediate assistance from a store associate, such as when the shoppers are in a hurry.

In an embodiment, store associates may be selected based on special needs of the customer. For example, the system may select a store associate who is good with children to assist customers who are shopping with children. A store associate may be selected specifically to help with older customers who may need wheelchair assistance. A store associate may be selected based on language proficiency to help with a customer who speaks a certain language. In some embodiments, a store associate may be selected based on the number of customers currently assigned to the store associate. The store associate with lower number of customers in his/her queue may be selected. As such, the customers may be distributed evenly among the store associates to spread out the store associates' work load.

Other factors for selecting the store associates may include their experience level, average checkout efficiency, and the like. Thus, multiple factors may be weighted and considered together when selecting a store associate for a customer. In another example, the store associate may be selected based on how much the customer is willing to wait. A customer may be in a hurry and need to checkout as soon as possible. Thus, the customer may be assigned a store associate who has high checkout efficiency (short average checkout time) and who is located the closest to the customer. A customer may be willing to browse the store longer and may be assigned a store associate who may spend more time with the customer to offer and provide additional service to the customer. The customer's willingness to wait may be indicated by the customer or may be determined based on the customer's shopping history.

In an embodiment, the shopper may be allowed to select a store associate from a list of available store associates. For example, the shopper may enjoy the service of a particular store associate and may prefer to be helped by the same person again. This allows the store associates to establish personal relationships with customers to retain the customers. The shopping app may allow a shopper to tip a store associate. For example, the shopping app may allow the user 105 to pay a tip to the store associate who is assigned to help the user 105 along with the payment for the purchased products. In an embodiment, the shopper may request multiple store associates, for example, if the shopper needs assistance moving and loading a heavy product into the shopper's car. The user 105 may use the shopping app to designate the number of store associates needed and the purpose for the request, such as moving a large product or need special assistance, such as handicap assistance.

At step 306, the system may communicate the information of the user 105 and the list of products placed in the user 105's shopping cart to the merchant device 140 of the selected store associate. The information of the user 105 may include the name of the user 105, a picture of the user 105, the location of the user 105 in the store, how long the user 105 has been waiting, the list of products being purchased by the user 105, total price of the purchase, payment method selected by the user 105, and the like. In another embodiment, the user may indicate a location the user plans to be at in the future, so that the store associate can meet the user at a later time and a different location. For example, the user may have a few more things to pick up, but wants to pre-notify the store, especially if the store is busy or understaffed. In this manner, the user wait may be less than if the user notifies the store when the user is actually ready for checkout. Thus, the selected associate may be notified to assist the user 105 with the checkout process at a particular location of the user or store at a current or future time. In some embodiments, additional information may be provided to the store associate that may allow the store associate to offer additional assistance or suggest additional products/services to the user 105. For example, the system may suggest that the store associate ask if the user 105 wishes to buy a bottle of wine, because the user 105 placed flowers in the shopping cart. In another example, the system may inform the store associate that the user 105 is a frequent customer and should provide VIP service to the user 105 or that the user 105 requires special assistance loading purchased products into his/her car, and the like. Suggestions may be communicated to the merchant device 140 carried by the store associate. Thus, the store associate may offer additional products/services to the user 105. In an embodiment, previous interactions and/or shopping history of the user 105 may be provided to the store associate. For example, the system may indicate to the store associate that the same store associate had helped the same user a certain number of times in the past. This may help the store associate remember previous interactions with the user 105 such that the store associate may provide personalized service to the user 105. In an embodiment, the system may allow the store associate to enter or input notes regarding the user 105 at the merchant device 140. For example, the store associate may wish to note that the user 105 typically prefers certain types of products or requires certain types of service. This may allow the store associate to record customers' personal preferences, such that personalized service may be provided to the customers.

At step 308, the system may communicate information about the selected store associate to the user device 110. The store associate information may include the store associate's name, picture, location, estimated wait time, estimated arrival time, and the like. Thus, the user 105 may be notified that a store associate has been assigned to help the user 105 with the checkout process. The system also may allow the user 105 to make additional requests, such as please help me find or pick up an item in the store for me before meeting me for checkout. This allows the user 105 to request for certain missing items in the shopping cart before the user 105 finalizes the shopping trip.

At step 310, the system may complete the checkout process. The store associate may meet the user 105 at the user's location and may review and confirm the products placed in the user's shopping cart with the list of products paid for by the user 105. For example, a list of products paid for by the user 105 may be presented to the store associate on the merchant device 140 as a check list. The store associate may check each product on the list with the products in the user 105's shopping cart. When all items are checked off, the checkout process may be finalized. After the store associate confirms the purchase at the merchant device 140, the system may finalize and complete the checkout process. Thus, the user 105 may pay for and checkout a purchase at any location in the store. The store associated may be assigned and notified to the user 105, such that the user 105 does not have to go to a checkout counter and wait in line to be checked out.

Accordingly, the portable POS device allows shoppers to pay and checkout in a store without having to stand in line at a checkout counter. This provides convenience and efficiency to the shoppers. The shoppers may continue to browse and shop while waiting for a store associate to meet them and check them out. This provides the store with opportunity to make additional sales. Because shoppers do not have to congregate at the checkout counter, the traffic bottleneck near the checkout counter is reduced or eliminated. Overall, the portable POS device/system provides flexibility and efficiency for both the retail merchants and shoppers.

The above processes 200 and 300 may be executed by user device 110. In some embodiments, the processes 200 and 300 may be executed at merchant device 140 or payment provider server 170. In some other embodiments, above processes 200 and 300 may be executed by one or more of user device 110, merchant device 140, and payment provider server 170 in coordination with each other.

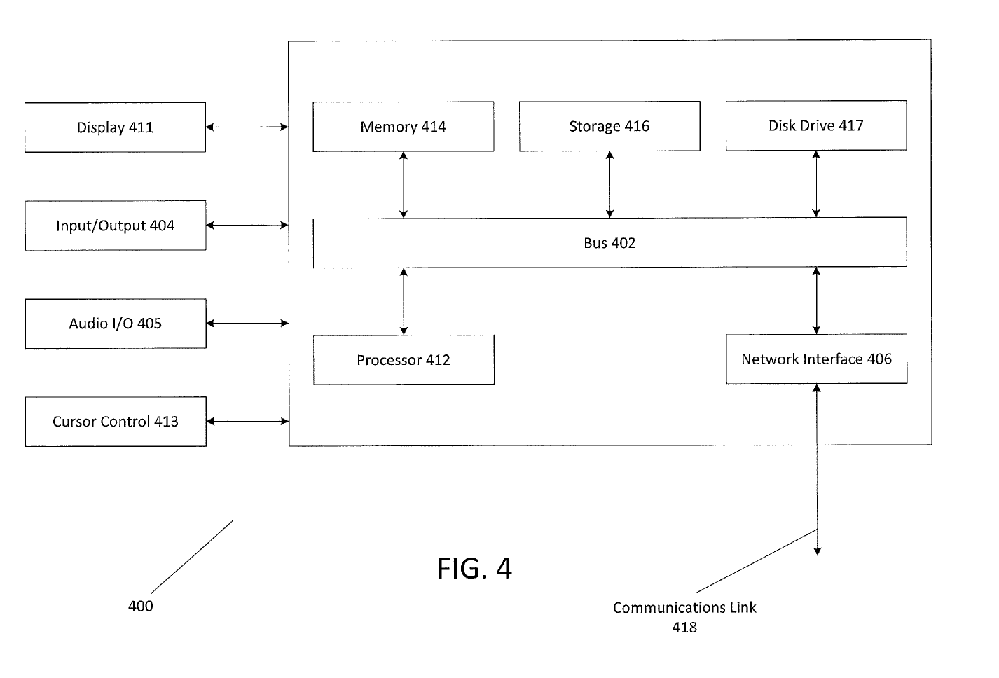

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A portable point-of-sale device comprising:
a display device configured to display a user interface for implementing in-store checkout process;
a user input device configured to receive user instructions for in-store checkout process;
a location detection device configured to detect in-store location of the portable point-of-sale device;
a non-transitory memory configured to store information related to an account of a merchant; and
one or more hardware processors coupled to the non-transitory memory and configured to read instructions from the non-transitory memory to cause the portable point-of-sale device to perform operations comprising:
receiving a notification to checkout a purchase made by a shopper in a store of the merchant, the request including a location of the shopper in the store as detected by a mobile shopping device of the shopper and a list of products of the purchase;
displaying, by the display device, the location of the shopper in the store and the list of products of the purchase made by the shopper;
receiving, by the user input device, a confirmation input by a store associate confirming the list of products correspond to products placed in a shopping cart of the shopper; and
in response to receiving the confirmation, finalizing the checkout process for the purchase made by the shopper.

2. The portable point-of-sale device of claim 1, wherein the operations further comprise:
detecting, by the location detection device, a location of the portable point-of-sale device in the store; and
communicating the location of the portable point-of-sale device to a mobile shopping device of the shopper.

3. The portable point-of-sale device of claim 2, wherein the location of the portable point-of-sale device is detected by a grid of Bluetooth beacons installed in the store.

4. The portable point-of-sale device of claim 1, wherein the operations further comprise:
receiving a queue of shoppers waiting to be checked out at the store and the locations of the shoppers;
providing directions to the locations of the shoppers; and
processing checkouts of the shoppers based on the queue.

5. A mobile shopping device comprising:
a display device configured to display a user interface for implementing in-store checkout process;
a user input device configured to receive user instructions for in-store checkout process;
a location detection device configured to detect in-store location of the mobile shopping device;
a non-transitory memory configured to store information related to an account of a shopper; and
one or more hardware processors coupled to the non-transitory memory and configured to read instructions from the non-transitory memory to cause the portable point-of-sale device to perform operations comprising:
receiving, by the user input device, a request from the shopper to checkout of a purchase made in a store of a merchant;
detecting, by the location detection device, a location of the mobile shopping device;
communicating the request and the location of the mobile shopping device to a portable point-of-sale device of a store associate; and
processing checkout of the purchase after receiving confirmation from the portable-point-of-sale device.

6. The mobile shopping device of claim 5, wherein the operations further comprise:
receiving a location of the store associate as detected by the point-of-sale device of the store associate; and
presenting, by the display device, an estimated wait time based on the location of the store associate and an availability of the store associate.

7. The mobile shopping device of claim 5, wherein the location of the mobile shopping device is detected via a grid of Bluetooth beacons installed in the store.

8. The mobile shopping device of claim 5, wherein the operations further comprise:
continuously detecting, by the location detection device, the location of the mobile shopping device while the shopper is waiting for the store associate to arrive; and
communicating updated location of the mobile shopping device to the portable point-of-sale device of the store associate in real time.

9. The mobile shopping device of claim 5, wherein the operations further comprise:
receiving, by the user input device, a payment request from the shopper for the purchase; and
processing a payment for the purchase based on the payment request.

10. The mobile shopping device of claim 9, wherein the payment is processed before finalizing checkout of the purchase by the portable point-of-sale device of the store associate.

11. A method comprising:
receiving, from a mobile shopping device of a shopper, a request to check out a purchase of the shopper made at a store of a merchant;
detecting a location of the mobile shopping device of the shopper in the store;
communicating the location of the shopper and a list of products of the purchase to a portable point-of-sale device of a store associate to notify the store associate of the request to check out;
receiving a confirmation from the portable point-of-sale device indicating that the store associate confirms the list of products of the purchase with products placed in a shopper cart of the shopper; and
finalizing checkout of the purchase in response to receiving the confirmation from the portable point-of-sale device.

12. The method of claim 11 further comprising:
detecting a location of the portable point-of-sale device of the store associate; and
communicating the location of the portable point-of-sale device to the mobile shopping device of the shopper.

13. The method of claim 11, where in the location of the mobile shopping device is detected by a grid of Bluetooth beacons installed in the store.

14. The method of claim 11 further comprising:
selecting the store associate from a plurality of store associates in the store; and
communicating a message to the portable point-of-sale device of the store associate notifying the store associate the shopper's request for checkout.

15. The method of claim 14, wherein the store associate is selected based on a number of customers waiting to be helped by each of the plurality of store associates.

16. The method of claim 14, wherein the store associate is selected based on a distance between the location of the shopper and a location of each of the plurality of store associates.

17. The method of claim 14, wherein the store associate is selected based on past interactions between the shopper and the store associates.

18. The method of claim 14, wherein the store associates is selected by matching a type of products being purchased by the shopper with an area of specialty of the store associate.

19. The method of claim 14, wherein the store associate is selected based on one or more of an experience level, an average checkout efficiency, and a language proficiency of the store associate.

20. The method of claim 11 further comprising:
continuously detecting the location of the mobile shopping device while the shopper is waiting for the store associate to arrive; and
communicating updated location of the mobile shopping device to the portable point-of-sale device of the store associate in real time.
